(19) United States
(12) Patent Application Publication
(10) Pub. No.: US 2008/0247727 A1
(43) Pub. Date: Oct. 9, 2008

(54) System for creating content for video based illumination systems

(75) Inventors: Jeremy R. Hochman, Austin, TX (US); Christopher Varrin, Los Gatos, CA (US); Matthew E. Ward, Philadelphia, PA (US)

Correspondence Address: Element Labs, Inc., 3350 Scott Blvd., Bldg 2, Santa Clara, CA, 95054, US

(73) Assignee: Element Labs, Inc., Santa Clara, CA (US)

(21) Appl. No.: 12/062,706

(22) Filed: Apr. 4, 2008

Related U.S. Application Data
(60) Provisional application No. 60/910,516, filed on Apr. 6, 2007.
(60) Provisional application No. 60/910,512, filed on Apr. 6, 2007.

(51) Int. Cl. H04N 5/93

(52) U.S. Cl. 386/52

(57) ABSTRACT

A method for generating lighting includes selecting a video clip from a database of generic video clips, processing at least a portion of the video clip to create a customized video clip, sending the customized video clip to a light emitting array, and generating lighting from the light emitting array based on the customized video clip.

### CROSS-REFERENCE TO RELATED APPLICATIONS

This application, pursuant to 35 U.S.C. § 119(e), claims priority to U.S. Patent Application Ser. No. 60/910,516 filed on Apr. 6, 2007 and entitled “A System for Creating Content for Video Based Illumination Systems” in the names of Jeremy Hochman, Christopher Varrin, and Matthew Ward, which is hereby incorporated by reference in its entirety. Further, still pursuant to 35 U.S.C. § 119(e), this application also claims priority to U.S. Patent Application Ser. No. 60/910,512 filed on Apr. 6, 2007 and entitled “Transport Control Module for Remote Use” in the name of Matthew Ward, which is hereby incorporated by reference in its entirety.

### BACKGROUND

1. Field of the Disclosure

Embodiments disclosed herein generally relate to generating dynamic lighting effects. More specifically, embodiments disclosed herein relate to a method and system for automatically generating lighting that may simulate the lighting from a separate location.

2. Background Art

The workflow of existing video playback systems, when utilized to provide a lighting effect, requires the film or video footage to be produced ahead of time in a special format that will provide the intended effect on stage. As used herein, the term “video playback” refers generically to the use of displayed or projected film or video as a lighting effect.

Systems for creating dynamic lighting effects designed to integrate real objects into artificial environments or, the converse, artificial objects into real environments are well known. Ultimatte is a well known manufacturer of equipment that provides video keying effects, such as those used by television stations, to place the weather presenter in front of a computer generated map or image. These systems have become very sophisticated and, by the early 1990's, had progressed to a point where real time computer animated figures, such as Nintendo's Mario, could be keyed or inserted over live action or prerecorded video game backgrounds.

Computer systems capable of putting computer animated characters in movies evolved around the same time. For example, Jaszlics et al in U.S. Pat. No. 6,166,744, “System for combining virtual images with real-world scenes” and Paul E. Debevec in U.S. Pat. No. 6,628,298, “Apparatus and method for rendering synthetic objects into real scenes using measurements of scene illumination” focus on the masking of a virtual character in the scene and the simulation of the lighting in the scene illuminating the computer animated character such that it may be integrated with other film or video footage. This computer generated lighting is designed to match the real world lighting that was present on the film or video footage that may have been shot in the studio or on location.

Debevec later progressed and devised a system to allow for the placement of a real subject into a scene of any kind as described in U.S. Pat. No. 6,685,326, “Realistic scene lighting simulation”. This system relies on data collected from the location to generate light in a second location. This is ideal for the layered effects shots used to place a human face on a computer generated body in a location shot which has been recorded months earlier.

These prior art systems disclose means for integrating computer animated effects and location shots and for incorporating real characters into computer generated backgrounds. However, the prior art systems generally fail to offer a stand alone design system.

In addition, prior art systems generally do not offer means to realistically simulate lighting in a natural environment. For example, there could be a desire to recreate the lighting conditions in which a camera is shooting two people in a moving convertible car down a tree-lined street on a sunny day. The goal is to recreate the impression of direct and reflected light on the two people and the car in a secondary environment that does not feature this natural lighting. The light is filtered through trees and reflected off adjacent cars. Some light hits the subjects directly. If simple prerecorded video of the scene is played back (as in the prior art systems), the image of a green leaf on a tree may cast green light on an actor's face. However, in reality, a person's face would not light up green. Instead, when a leaf is present it may create a shadow because it is blocking the sun. Accordingly, there exists a need for a system that may be able to integrate these techniques using a video playback system.

### SUMMARY OF THE INVENTION

In one aspect, embodiments disclosed herein relate to a method for generating lighting that includes selecting a video clip from a database of generic video clips, processing at least a portion of the video clip to create a customized video clip, sending the customized video clip to a light emitting array, and generating lighting from the light emitting array based on the customized video clip.

In another aspect, embodiments disclosed herein relate to a system for generating lighting including a database of generic video clips, a computer configured to import and process at least a portion of a video clip from the database to generate a customized video clip, and a light emitting array configured to generate lighting based on the customized video clip.

In yet another aspect, embodiments disclosed herein relate to a method for generating lighting adjusted for local lighting conditions that includes selecting a video clip from a database of generic video clips, processing at least a portion of the video clip to create a customized video clip, sending the customized video clip to a light emitting array, generating lighting from the light emitting array based on the customized video clip, measuring local lighting conditions, and adjusting the generated lighting based on the measurement of the local lighting.

Further, in yet another aspect, embodiments disclosed herein relate to a system for generating lighting adjusted for local lighting conditions including a database of generic video clips a computer configured to import and process at least a portion of a video clip from the database to generate a customized video clip, a light emitting array configured to generate lighting based on the customized video clip, and a light sensor configured to measure local lighting conditions.

### BRIEF DESCRIPTION OF DRAWINGS

FIG. 1 shows a block diagram of a video processing path in accordance an embodiment of the present disclosure.

FIG. 2 shows a block diagram of a video processing path in accordance an embodiment of the present disclosure.

FIG. 3 shows a block diagram of a video processing path in accordance an embodiment of the present disclosure.

FIG. 4 shows a system controller in accordance with an embodiment of the present disclosure.

### DETAILED DESCRIPTION

One or more embodiments of the present disclosure provide a method of quickly and efficiently generating video lighting effects using location or locally generated video content which may be combined with records of location light levels. The workflow of this new system may allow a user to freely try new approaches and settings that may not be feasible beforehand. The system is not limited to integrating computer animated effects and locations shots or to incorporating real characters into computer generated backgrounds. In one or more embodiments, the disclosed system may give production lighting directors and directors of photography the freedom to create a dynamic key and background lighting environment on a set even when the target location lighting was not recorded.

In one or more embodiments of the present disclosure, the process is intuitive and the user may respond to changes and feedback immediately. If there is a video clip available the user may import the video clip into the software. The software may then identify edges and motion. The user may select a portion of the video clip to be used as a source for illumination. The selected portion may be an entire frame of a video clip, or only a selected area of a frame of a video clip. Furthermore, the selected portion may be a specific time section of a video clip. The user may then scale the portion to be used as a source for illumination. Furthermore, the user may locate the portion anywhere within a frame of the video clip. This information may be used to create a template that the user may further adjust to suit the exact needs of the shot.

For example, a video clip of a scene including trees may be imported into the software. The user may choose to create a template using only the trees from the video clip, and, thus, may select a portion of a frame containing the trees. Then, the user may scale the trees to be of any size within the frame of the video clip, and the user may further locate the trees anywhere within the frame of the video clip.

In one or more embodiments of the present disclosure, a system controller may allow an operator to adjust the settings remotely. The controller may take an input from the camera in order to synchronize the lighting and the camera movement for effects shots. The controller may allow an operator to adjust dynamic lighting values while standing in front of the subject being lit or while looking through the camera.

Further, in one or more embodiments of the present disclosure, the color of such dynamic lighting may not be as important as intensity and shading, and a de-saturated close-to-grayscale image may be preferable. Furthermore, because general lighting conditions fall into a soft light category, a lower resolution video image may be preferable. For example, instead of the detailed, green leaf from a video as mentioned in the above example, an improved result may be achieved by processing the signal and illuminating the subject with a darkened diffuse oval spot to more correctly represent the lighting effect caused by a leaf shadow.

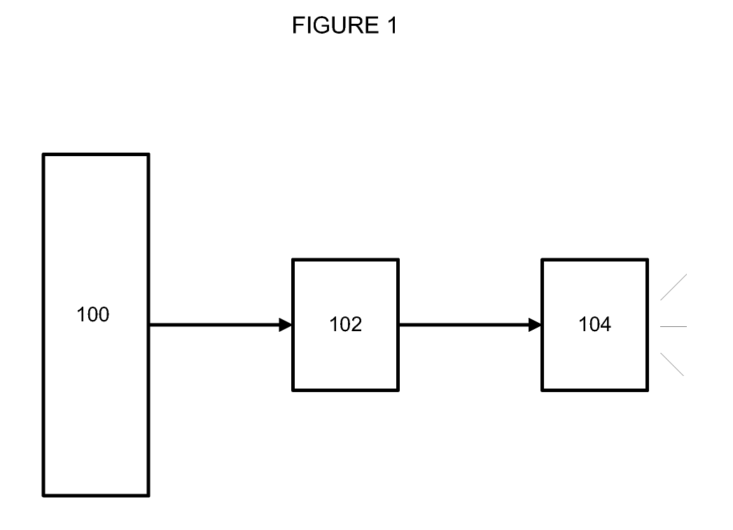

FIG. 1 shows a video processing path in accordance with one or more embodiments of the present disclosure. In this simple embodiment a video signal is imported in stage 100. For example, the video signal may be imported by a computer, and further processed by the computer. The video signal may be derived from a source selected from, but not limited to: pre-recorded video or film clip, video clip library, media server, local video source such as a video camera, and locally generated video signal using computer generated imagery (“CGI”) or any combination thereof.

More generally, a video clip may be imported into the video processing path as a video signal from a database of generic video clips. In one or more embodiments of the present disclosure, a database of generic video clips is a collection of one or more generic video clips. Furthermore, in one or more embodiments of the present disclosure, a generic video clip may be a video clip that was not produced in advance in a special format such that the video clip generates the intended lighting. Rather, a generic video clip may or may not have been preproduced, but will still require video processing to generate the intended lighting.

The video signal is then passed to the video processing stage 102, which may apply the signal processing stages described above to the video signal under the control of the operator to generate a customized video clip. Such processing at this basic level may include, for example, contrast adjustment, edge softening, and de-saturation.

The customized video clip is then passed as a processed video signal to a light emitting array 104, which may illuminate the scene under the control of the processed video signal. The light emitting array 104 may be one or multiple video projectors utilizing liquid crystal display (“LCD”) panels, digital micromirror device (“DMD”) chips or other light valve systems known to those skilled in the art. In another embodiment, the light emitting array 104 may include an array of light emitting diodes (“LEDs”). The LEDs may include one or more colors, and may include a single array or multiple arrays distributed around the set. In a further embodiment the light emitting array 104 may comprise LED Strips or individual LED nodes.

In a further embodiment, the LED nodes (pixels) in the light emitting array 104 may be constructed with a single beam angle or may contain multiple LEDs with different beam angles. In such a system the operator and control system may select the beam angle or combination of beam angles. In a yet further embodiment, the LED nodes may be constructed with multiple LEDs angled in differing orientations. In such a system, the operator and control system may select the beam direction.

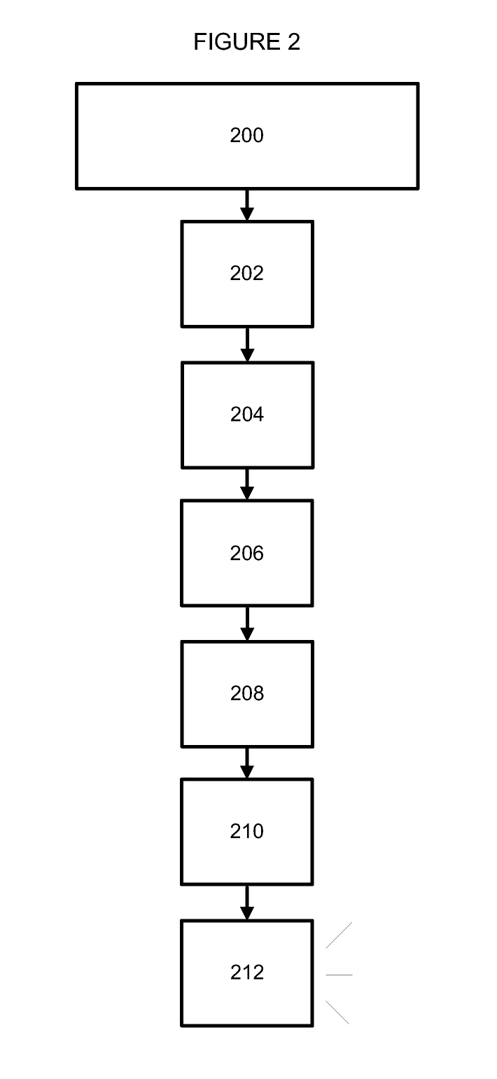

FIG. 2 shows another video processing path in accordance with one or more embodiments of the present disclosure. A generic video clip may be imported as a video signal in stage 200 in the same manner as described for FIG. 1. The video signal then passes through one or more stages of signal processing, such as the stages 202-210, to generate a customized video clip. Those skilled in the art will appreciate that any type of signal processing may be applied to the video signal. That is, embodiments of the present disclosure are not limited to the stages of signal processing 202-210 shown in FIG. 2. Furthermore, the video signal is not required to pass through each stage of signal processing shown in FIG. 2. Even further, each stage of signal processing may be under control of the operator.

Specifically, in the embodiment of FIG. 2, after the video signal is imported, local lighting values are imported into the software in stage 202. Next, the software defines edges in the video signal in stage 204. Then, the user may define the speed of an object or background in the video signal in stage 206. The video signal may then be exported to a particle generator in stage 208. The particle generator may add different styles to the video signal, in which each style may be added in a new layer. Any further processing may then be applied to the video signal in stage 210 to create the customized video clip.

After passing through one or more stages or signal processing, the customized video clip is passed to the light emitting array 212 as a processed video signal. In one or more embodiments of the present disclosure, the light emitting array 212 may be similar to the light emitting array 104 of FIG. 1.

Through the one or more stages of signal processing, the user may adjust settings such as speed and direction of an object or background in the video signal. In some situations, it may be desirable to have the speed of an object or background vary from one section of the frame to another. The speed of an object or background may be defined or changed as shown in stage 206. It may also be desirable to have different portions, objects, or backgrounds of the finished video signal moving in opposite directions. The user may define these parameters before adding additional layers.

Different styles such as leaves, trees, buildings, glass, lines, circles, reflections, and other shapes may be layered over the template. In one or more embodiments of the disclosure, such styles may be created and added to the video signal using a particle generator, as illustrated in stage 210. Furthermore, the user may adjust one or more settings of each style, including, but not limited to, size, speed of movement, direction of movement, creation rate, removal rate, growth rate, color, transparency, saturation, contrast, and texture. The adjustment of these settings may be accomplished through the particle generator or after the particle generator has created the style.

The user may set the overall color temperature of the generated lighting at any point in the process. Such control may be driven open loop or, with the addition of sensors to measure the actual color temperature of the light on the subject, closed loop. Further, the user may set the overall color of the generated lighting at any point in the process. This color may be chosen to match the colors of standard theatrical gels or other color standards well known in the art.

The system may utilize measurement and input of actual local lighting levels to dynamically modify the generated lighting. For example the scene may be lit with a local key light; the lighting level of this key light could be measured and fed as an input to the generated lighting system, as shown in stage 202. The generated lighting system may then adjust the level of the superimposed lighting effect to match and enhance the illumination from the key light. If the effect was rain, for example, the rain effect may be kept at a lower level than the key light to avoid destroying the illusion of reality with unrealistic lighting levels.

A Lighting Designer, a Director of Photography, or other user may then use light as a three dimensional object. By using multiple lighting arrays, it is possible to build up a look that will have the depth and the appearance of a natural environment.

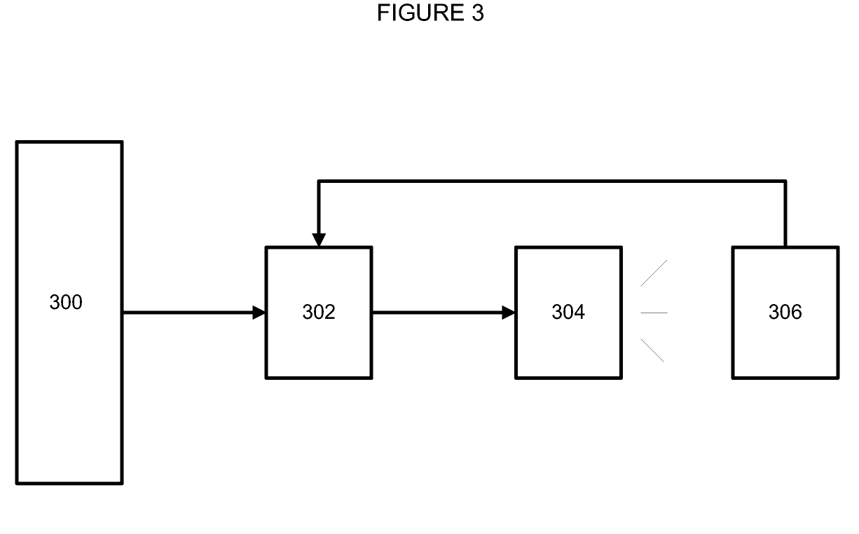

FIG. 3 shows another video processing path in accordance with one or more embodiments of the present disclosure. A generic video clip may be imported as a video signal in stage 300 in the same manner as described for FIG. 1. The video signal is passed to the video processing stage 302, which may apply the signal processing stages described above to the video signal under the control of the operator to generate a customized video clip. The customized video clip is then passed as a processed video signal to a light emitting array 304, which may illuminate the scene under the control of the processed video signal.

A light sensor 306 is placed in the controlled scene in order to measure local lighting conditions. Light sensor 306 is connected to video processing stage 302, which updates the signal processing stages applied to the video signal in order to generate a customized video clip that is adjusted to the local lighting conditions. Light sensor 306 may be any suitable sensor known in the art, such as, for example, a photodiode, a phototransistor, a charge coupled device (“CCDs”), an image sensor, a digital camera, a photometer, a calorimeter, and a video camera. Alternatively, multiple light sensors may be placed throughout the controlled scene, and the signal processing stages applied to the video signal may be adjusted based on one or more of the light sensors. Light sensor 306 may measure, for example, optical properties such as luminance, chromaticity, and color temperature of the local lighting conditions in order to adjust the customized video clip.

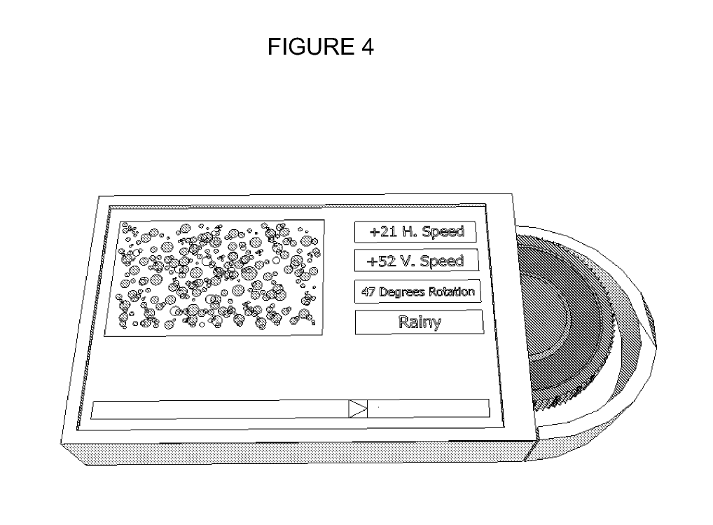

FIG. 4 is a diagram of an embodiment of the present disclosure showing one possible simple system controller. Through this controller the user may select from the multiple macro or mood settings including, for example, but not limited to: “reflection”, “rainy day”, “spring day”, “night club”, “forest”, “seascape”, “city”, “subway station”, “shopping mall”, “firelight”, “candlelight”, “stained glass window”, “underwater”, “outer space”, or “attack of the paparazzi”. The user may layer and use multiple macros simultaneously so that “reflection” and “spring day” may both be used. The settings in the different macros may further be controlled independently.

In a further embodiment, the system may utilize performer tracking systems, such as Infra Red (IR) or radio frequency (RF) tracking systems or any other tracking system known in the art. The dynamic lighting control system may then use this position tracking data to control the parameters of the system so as to change the lighting on a performer as they move.

Embodiments disclosed herein may provide for one or more of the following advantages. First, the present disclosure may provide for a method of quickly and efficiently generating video lighting effects using location or locally generated video content which may be combined with records of location light levels. The workflow of this new system may allow a user to freely try new approaches and settings that may not be feasible beforehand. Next, the present disclosure may provide for a system that allows an operator to adjust lighting effects settings remotely. The present disclosure may also provide for a system and method of generating lighting for customized video clips that is adjusted to local lighting conditions.

While the invention has been described with respect to a limited number of embodiments, those skilled in the art, having benefit of this disclosure, will appreciate that other embodiments may be devised which do not depart from the scope of the invention as disclosed herein. Accordingly, the scope of the invention should be limited only by the attached claims.

What is claimed is:

1. A method for generating lighting, comprising:
selecting a video clip from a database of generic video clips;
processing at least a portion of the video clip to create a customized video clip;
sending the customized video clip to a light emitting array; and
generating lighting from the light emitting array based on the customized video clip.

2. The method of claim 1, wherein the at least a portion of the video clip comprises at least one of a time portion and an area portion.

3. The method of claim 2, wherein processing the video clip further comprises changing a size of the selected portion.

4. The method of claim 2, wherein processing the video clip further comprises changing a location of the selected portion.

5. The method of claim 1, wherein processing the video clip comprises defining a speed of an object in the video clip.

6. The method of claim 1, wherein processing the video clip comprises layering a style over the video clip.

7. The method of claim 6, wherein a particle generator is used to layer the style over the video clip.

8. The method of claim 1, further comprising setting a color temperature of the generated lighting.

9. The method of claim 1, further comprising measuring the generated lighting.

10. The method of claim 9, wherein generating lighting is further based on the measurement of the generated lighting.

11. The method of claim 1, further comprising directing the generated lighting to a subject.

12. The method of claim 1, further comprising tracking movement of a subject, wherein generating lighting is further based on the movement of the subject.

13. A system for generating lighting, comprising:
a database of generic video clips;
a computer configured to import and process at least a portion of a video clip from the database to generate a customized video clip; and
a light emitting array configured to generate lighting based on the customized video clip.

14. The system of claim 13, wherein the light emitting array comprises a plurality of light emitting elements.

15. The system of claim 13, wherein a beam angle of one of the light emitting elements is different from a beam angle of another of the light emitting elements.

16. The system of claim 13, wherein a beam direction of one of the light emitting elements is different from a beam direction of another of the light emitting elements.

17. The system of claim 13, further comprising a tracking system configured to track movement of a subject onto which the generated lighting is directed.

18. The system of claim 17, wherein the generated lighting is further based on the movement of the subject.

19. A method for generating lighting adjusted for local lighting conditions, comprising:
selecting a video clip from a database of generic video clips;
processing at least a portion of the video clip to create a customized video clip;
sending the customized video clip to a light emitting array;
generating lighting from the light emitting array based on the customized video clip;
measuring local lighting conditions; and
adjusting the generated lighting based on the measurement of the local lighting.

20. The method of claim 19, further comprising measuring the generated lighting.

21. The method of claim 19, wherein adjusting the generated lighting is further based on the measurement of the generated lighting.

22. A system for generating lighting adjusted for local lighting conditions, comprising:
a database of generic video clips;
a computer configured to import and process at least a portion of a video clip from the database to generate a customized video clip;
a light emitting array configured to generate lighting based on the customized video clip; and
a light sensor configured to measure local lighting conditions.

23. The system of claim 22, wherein the light emitting array comprises a plurality of light emitting elements.

24. The system of claim 22, further comprising a tracking system configured to track movement of a subject onto which the generated lighting is directed.
